(19) United States
(12) Patent Application Publication
(10) Pub. No.: US 2025/0029400 A1
(43) Pub. Date: Jan. 23, 2025

(54) A METHOD FOR DETERMINING A DIMENSION OF AN OBJECT

(71) Applicant: AUTOBRAINS TECHNOLOGIES LTD, Tel Aviv-Yafo (IL)

(72) Inventor: Igal Raichelgauz, Tel Aviv (IL)

(73) Assignee: AUTOBRAINS TECHNOLOGIES LTD, Tel Aviv-Yafo (IL)

(21) Appl. No.: 18/354,630

(22) Filed: Jul. 18, 2023

(51) Int. Cl. G06V 20/56; B60W 60/00; G06T 7/70

(52) U.S. Cl. CPC G06V 20/588; B60W 60/00; G06T 7/70; B60W 2420/403; G06T 2207/30252

(57) ABSTRACT

A method for calculating a dimension of an object, the method comprises: (a) receiving an image that was acquired by a vehicle camera of a vehicle; the image captures the horizon, the object, and road lane boundaries; (b) determining an initial row-location horizon estimate and a row-location contact point estimate, the row-location contact point estimate represents a contact between the object and a road on which the vehicle is positioned; (c) determining a vehicle camera pitch angle correction and an actual vehicle camera pitch angle, wherein the vehicle camera pitch angle correction, once applied, will cause the road lanes boundaries to be parallel to each other in a real world; (d) calculating the distance between the vehicle and the object based the determined values; and (e) determining the dimension of the object based on the focal length of the vehicle camera, a corresponding dimension of the object within the image and the distance between the vehicle camera and the object.

### BACKGROUND

Autonomous vehicles and/or driver assistance systems are required to detect objects within the field of view of their cameras. The object detection may benefit from evaluating the dimensions of the objects. For example—it may be beneficial to distinguish between an adult and a child-using their height—as the behavior of a child may be less predictable than the behavior of an adult. The difference between the behavior of a chine and an adult may impact the manner in which an autonomous vehicle should drive at the presence of a road user that is a pedestrian. The same applies to a driver assistance system.

There is a growing need to provide an accurate method for determining a dimension of an object.

### SUMMARY

There may be provided a method, a system and a non-transitory computer readable medium for determining a dimension of an object.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a horizon calculation;

FIG. 2 illustrates an example of a method;

FIG. 3 illustrates an example of a method; and

FIG. 4 illustrates an example of a vehicle.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

The specification and/or drawings may refer to an information unit. The information unit may be a sensed information unit. The sensed information unit may capture or may be indicative of a natural signal such as but not limited to signal generated by nature, signal representing human behavior, signal representing operations related to the stock market, a medical signal, audio signal, visual information signal, and the like. Sensed information may be sensed by any type of sensors-such as a visual light camera, or a sensor that may sense infrared, radar imagery, ultrasound, electro-optics, radiography, LIDAR (light detection and ranging), etc.

The specification and/or drawings may refer to a processor. The processor may be a processing circuit. The processing circuit may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There may be provide a system, a method, and a non-transitory computer readable medium for determining a dimension of an object.

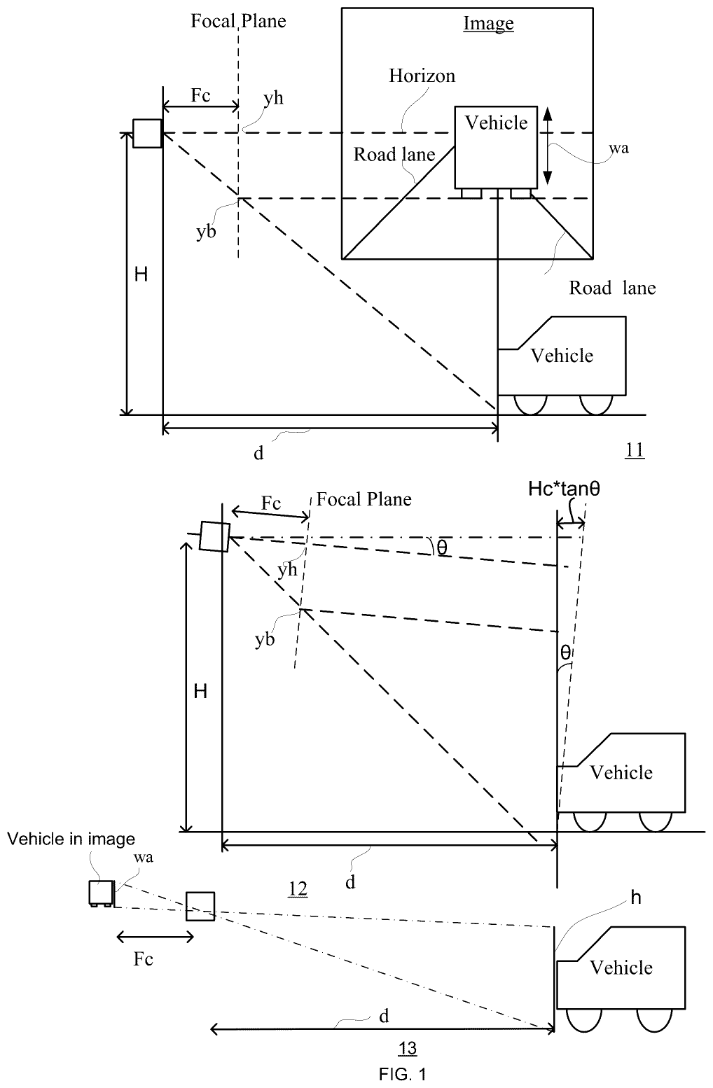

FIG. 1 includes two images—one illustrates a calculation of a distance between a vehicle camera that captures an image in which an object appears, and the object—when the vehicle camera is horizontal—and one image illustrates the calculation when there is a pitch angle.

When the camera is horizontal—the distance is calculated by d=(F_{C}−H_{C})/(y_{b}−yₕ).

Wherein d is the distance between the vehicle camera and the object, F_{C} is a distance between the vehicle camera and an image plane, H_{C} is a distance between the vehicle camera and the road (may be regarded as the height of the vehicle camera), y_{b} is a line (row) in the image of a point of contact between the object and the road (bottom line), and yₕ is a line (row) in the image of the horizon.

This equation provides inaccurate results if the optical axis of the vehicle camera is not horizontal—where there is a non-zero pitch angle. A positive non-zero pitch angle of the vehicle angle “moves” the horizon downwards in the image while a negative non-zero pitch angle of the vehicle angle “moves” the horizon upwards in the image. These movements may introduce significant errors in the value of yₕ.

When there is a non-zero vehicle camera pitch angle then the distance is calculated by

$$d = \frac{1}{{cos}^{2} θ} * \frac{Fc * H}{yc - yh} - H * tan θ$$

Wherein θ is the pitch angle of the vehicle camera and H is a horizon estimate.

FIG. 1 also illustrates the relationships between the dimension (h) of the vehicle, the dimension of the vehicle within the image (wa), the focal length of the vehicle camera F_{C} and the distance d between the object and the vehicle camera.

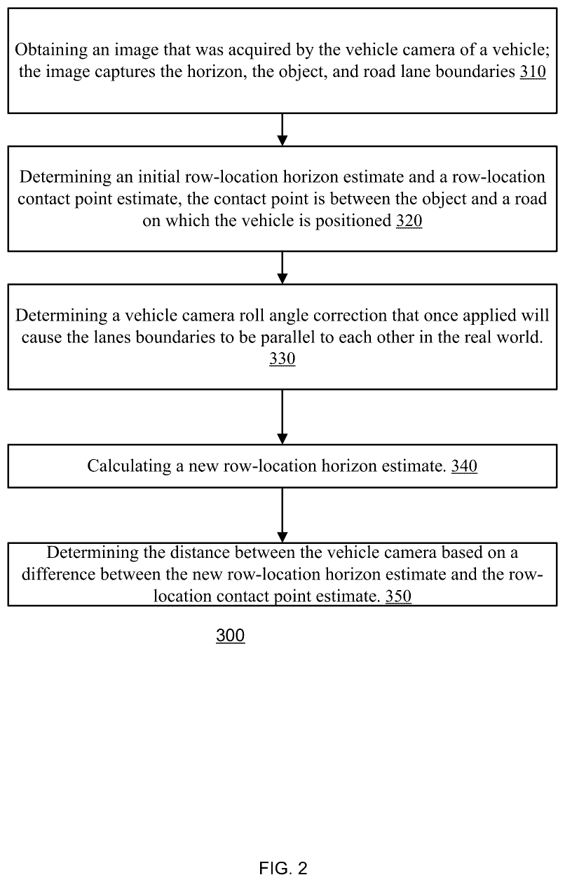

FIG. 2 illustrates an example of a method 300 for calculating a distance between a vehicle camera and an object-which also includes determining the camera pitch angle.

Method 300 may start by step 310 of obtaining an image that was acquired by the vehicle camera of a vehicle. The image captures the horizon, the object, and road lane boundaries.

Step 310 may be followed by step 320 of determining an initial row-location horizon estimate and a row-location contact point estimate. The vehicle and the object contact the same road. The contact point represent a contact between the object vehicle and the road.

Step 320 may include applying the following equation: d=(F_{C}−H_{C})/(y_{b}−yₕ).

Step 320 may be followed by step 330 of determining a vehicle camera pitch angle correction that once applied will cause the road lanes boundaries to be parallel to each other in the real world.

Step 330 may be executed in an iterative manner, in an analytical manner, and the like.

Since the horizon (yₕ) is used in the equation d=(F_{C}−H_{C})/(y_{b}−yₕ) it directly affects the coordinates of each line point in the world coordinates. The rest of the parameters in the equation are constant.

Step 330 may be followed by step 340 of calculating a new row-location horizon estimate.

The calculating of the new row-location may include updating the row-location horizon estimate based on the vehicle camera pitch angle correction. If the camera is tilted downwards the updating may include moving the row-location horizon estimate upwards—and vice verse.

Step 340 may be followed by step 350 of determining the distance between the vehicle camera based on a difference between the new row-location horizon estimate and the row-location contact point estimate.

Steps 320, 330, 340 and 350 may be executed by a vehicle processing circuit, in real time, and per image. Thus-they may be executed tens of times per second.

The following example illustrates various steps that can be applied once per each frame or once for each set of frames (for example once per first lane boundary estimate).

A. The steps may include transforming pixel (Xim, Yim) coordinates to the world (Xw, Zw) coordinates done with the following equations:
a. For the longitudinal axis, Zw=(Fc*Hc)/(Yb−Yh)
b. Where Fc is camera focal length, Hc is camera height, Yh is the vertical coordinates of the horizon and Yb is the vertical coordinates of the lane point (Yim).
c. For the lateral axis, Xw=(Hc*(Xim−Cx))/(Yb−Yh).

Where Hc is camera height, Xim is x image, Cx is the center x, Yh is the vertical coordinates of the horizon and Yb is the vertical coordinates of the lane point (Yim).

B. Initializing the location of the horizon (may be set in advance, may be determined based on previous frames, based on the location of the acquisition of the image, and the like).

C. Getting an estimate of a right lane border and a left lane border.

D. Determining a lane segment that has both right lane border and left lane border.

E. Selecting within the lane segment samples points at multiple distances. For-example select 5, 10, 50, 20 and the like distances (in the real world) and select a right lane border point and left border point per distance.

F. For each z-axis distance-calculating the (real world) estimated land width (x axis distance) between a right lane border point and left border point of that z-axis distance to obtain multiple estimated lane widths-one estimated lane width per z-axis distance.

E. Checking the validity of each estimated land width (for example whether it is within an expected lane width value).

F. Calculating, based on the estimated land widths and the z-axis distances between the estimated land widths-lane borders slopes-rate of change of estimated land width over the z-axis.

The amount of horizon correction (y-axis of the image) may be a function of the rate of change of estimated land width over the z-axis—for example may be the rate of change of estimated land width over the z-axis multiplied by a factor (for example 2-20, 6, and the like). The amount of horizon correction may be clipped-in order to provide a moderate change.

G. After setting the new horizon-jumping to getting a new estimate of the right lane border and a left lane border.

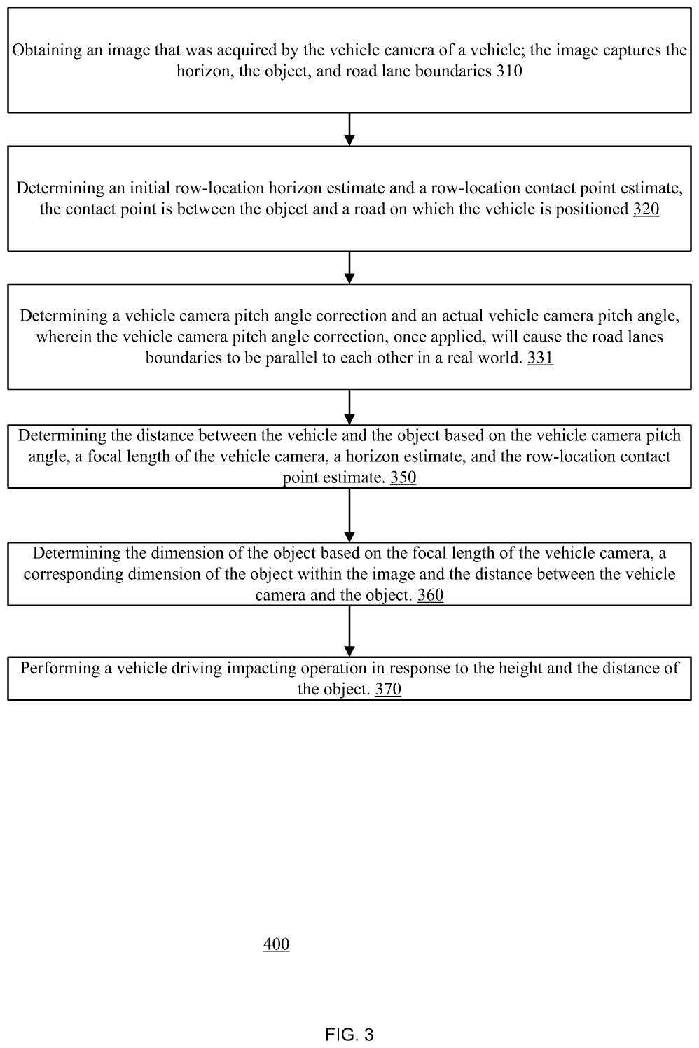

FIG. 3 illustrates an example of a method 400 for calculating a dimension of an object.

Method 400 may start by step 310 of obtaining an image that was acquired by a vehicle camera of a vehicle. The image captures the horizon, the object, and road lane boundaries.

Step 310 may be followed by step 320 of determining an initial row-location horizon estimate and a row-location contact point estimate. The vehicle and the object contact the same road. The row-location contact point estimate represents a contact between the object and a road on which the vehicle is positioned.

Step 320 may be followed by step 330 of determining a vehicle camera pitch angle correction and an actual vehicle camera pitch angle. The vehicle camera pitch angle correction, once applied, will cause the road lanes boundaries to be parallel to each other in a real world.

Step 330 may be followed by step 350 of determining the distance between the vehicle and the object based on the vehicle camera pitch angle (θ), a focal length (Fc) of the vehicle camera, a horizon estimate (H), the row-location contact point estimate (yb).

$$d = \frac{1}{{cos}^{2} θ} * \frac{Fc * H}{yc - yh} - H * tan θ .$$

Step 350 may include calculating:

The dimension of the object may be a height of the object—or another dimension.

The horizon estimate H may be an initial row-location horizon estimate

Method 300 may include calculating a new row-location horizon estimate, wherein the calculating may include updating the row-location horizon estimate based on the vehicle camera pitch angle correction.

The horizon estimate H may be the new row-location horizon estimate

Step 350 may be followed by step 360 of determining the dimension of the object based on the focal length of the vehicle camera, a corresponding dimension of the object within the image and the distance between the vehicle camera and the object. This may be done using triangle similarities.

Step 360 may include multiplying the distance by a ratio between the (i) the dimension of the object within the image, and (ii) the focal length of the camera.

According to an embodiment, step 360 is followed by step 370 of performing a vehicle driving impacting operation in response to the height and the distance of the object.

Step 370 may include autonomously driving the based on the dimension of the object and the distance between the vehicle and the object.

Step 370 may include performing a driver assistance operation (for example—alerting a driver, suggesting a driving path or other action to the driver, performing an emergency breaking, performing a lane related driving operation, and the like).

Steps 320-370 may be executed by a vehicle processing circuit, in real time, and per image. Real time may include multiple time per second (for example at least 5, 10, 20, 30, 40, 50, 60, 100, 200 times a second).

The suggested method provide a distance estimate between the object and the vehicle camera and the dimension of the object in a highly accurate manner (determination based on locations of the horizon in the image), and also relatively simple (which saves computational and memory resources)—especially as the method may use the byproduct of lane detection process (locations of lanes)—which are generated for multiple other purposes (such as determining the location of the vehicle, maintaining lane, and the like). The method may operate even when the vehicle camera is not horizontal—even when there is a non-zero pitch angle—and is also robust.

The method may be executed in real time—which is mandatory as various autonomous driving operations and/or driving assistance operations must be executed in real time—and processing images that may include even millions of pixels is a highly complex task that requires non-transitory processors and/or processing circuits.

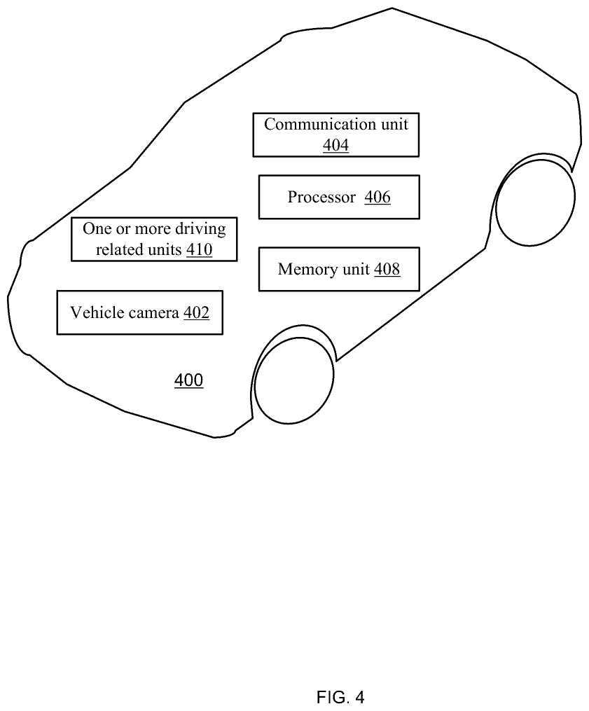

FIG. 4 illustrates an example of vehicle 400.

Vehicle 400 may include vehicle camera 402 (or any number of any sensing units), processor 406 that may include one or more processing circuitries, memory unit 408 for storing information and/or instructions (any type of non-transitory memory units may be used), a communication unit 404 that may be configured to communicate with components in the vehicle and/or outside the vehicle, and one or more driving related units 410 such as (i) one or more autonomous driving units that is configured to control or otherwise execute autonomous driving and/or (ii) one or more driver assistance units such as ADAS units. The vehicle is configured to execute any of the mentioned above methods.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method-respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on non-transitory computer readable media permanently, removably or remotely coupled to an information processing system. The non-transitory computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuit located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuit or of logical representations convertible into physical circuit, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for providing dimensional information related to an object, the method comprises:
(a) receiving an image that was acquired by a vehicle camera of a vehicle; the image captures the horizon, the object, and road lane boundaries;
(b) determining an initial row-location horizon estimate and a row-location contact point estimate, the row-location contact point estimate represents a contact between the object and a road on which the vehicle is positioned;
(c) determining a vehicle camera pitch angle correction and an actual vehicle camera pitch angle, wherein the vehicle camera pitch angle correction, once applied, will cause the road lanes boundaries to be parallel to each other in a real world;
(d) calculating the distance between the vehicle and the object based on the vehicle camera pitch angle, a focal length of the vehicle camera, a horizon estimate, the row-location contact point estimate; and
(e) determining the dimension of the object based on the focal length of the vehicle camera, a corresponding dimension of the object within the image and the distance between the vehicle camera and the object.

2. The method according to claim 1 wherein steps (b)-(e) are executed by a vehicle processing circuit, in real time, and per image.

3. The method according to claim 1 wherein the determining of the vehicle camera pitch angle correction comprises calculating point to point distances between points of different road boundaries.

4. The method according to claim 1 wherein the calculating of the dimension of the vehicle comprises multiplying the distance by a ratio between the (i) the dimension of the object within the image, and (ii) the focal length of the camera.

5. The method according to claim 1 wherein the dimension of the object is a height of the object.

6. The method according to claim 1 wherein the horizon estimate is the initial row-location horizon estimate.

7. The method according to claim 1 comprising calculating a new row-location horizon estimate, wherein the calculating comprises updating the row-location horizon estimate based on the vehicle camera pitch angle correction.

8. The method according to claim 7 wherein the horizon estimate is the new row-location horizon estimate.

9. The method according to claim 1 comprising autonomously driving the based on the dimension of the object and the distance between the vehicle and the object.

10. A non-transitory computer readable medium for providing dimensional information related to an object, the non-transitory computer readable medium stores instructions for
(a) receiving an image that was acquired by a vehicle camera of a vehicle; the image captures the horizon, the object, and road lane boundaries;
(b) determining an initial row-location horizon estimate and a row-location contact point estimate, the row-location contact point estimate represents a contact between the object and a road on which the vehicle is positioned;
(c) determining a vehicle camera pitch angle correction and an actual vehicle camera pitch angle, wherein the vehicle camera pitch angle correction, once applied, will cause the road lanes boundaries to be parallel to each other in a real world;
(d) calculating the distance between the vehicle and the object based on the vehicle camera pitch angle, a focal length of the vehicle camera, a horizon estimate, the row-location contact point estimate; and
(e) determining the dimension of the object based on the focal length of the vehicle camera, a corresponding dimension of the object within the image and the distance between the vehicle camera and the object.

11. The non-transitory computer readable medium according to claim 10 wherein steps (b)-(e) are calculated by a vehicle processing circuit, in real time, and per image.

12. The non-transitory computer readable medium according to claim 10 wherein the determining of the vehicle camera pitch angle correction comprises calculating point to point distances between points of different road boundaries.

13. The non-transitory computer readable medium according to claim 10 wherein the calculating of the dimension of the vehicle comprises multiplying the distance by a ratio between the (i) the dimension of the object within the image, and (ii) the focal length of the camera.

14. The non-transitory computer readable medium according to claim 10 wherein the dimension of the object is a height of the object.

15. The non-transitory computer readable medium according to claim 10 wherein the horizon estimate is the initial row-location horizon estimate.

16. The non-transitory computer readable medium according to claim 10 comprising calculating a new row-location horizon estimate, wherein the calculating comprises updating the row-location horizon estimate based on the vehicle camera pitch angle correction.

17. The non-transitory computer readable medium according to claim 16 wherein the horizon estimate is the new row-location horizon estimate.

18. The non-transitory computer readable medium according to claim 10 comprising autonomously driving the based on the dimension of the object and the distance between the vehicle and the object.

19. A vehicle processing circuit that is configured to:
(a) receive an image that was acquired by a vehicle camera of a vehicle; the image captures the horizon, the object, and road lane boundaries;
(b) determine an initial row-location horizon estimate and a row-location contact point estimate, the row-location contact point estimate represents a contact between the object and a road on which the vehicle is positioned;
(c) determine a vehicle camera pitch angle correction and an actual vehicle camera pitch angle, wherein the vehicle camera pitch angle correction, once applied, will cause the road lanes boundaries to be parallel to each other in a real world;
(d) calculate the distance between the vehicle and the object based on the vehicle camera pitch angle, a focal length of the vehicle camera, a horizon estimate, the row-location contact point estimate; and
(e) determine the dimension of the object based on the focal length of the vehicle camera, a corresponding dimension of the object within the image and the distance between the vehicle camera and the object.
